(19) United States
(12) Patent Application Publication
(10) Pub. No.: US 2019/0273295 A1
(43) Pub. Date: Sep. 5, 2019

(54) REGENERATIVE SOLID-SOLID PHASE CHANGE COOLING FOR AN ENERGY STORAGE DEVICE

(71) Applicant: ANHUI XINEN TECHNOLOGY CO., LTD., Anqing Anhui (CN)

(72) Inventors: John R. Chan, Fremont, CA (US); Amy Chan, Fremont, CA (US)

(21) Appl. No.: 15/957,698

(22) Filed: Apr. 19, 2018

Related U.S. Application Data
(60) Provisional application No. 62/638,488, filed on Mar. 5, 2018.

(51) Int. Cl. H01M 10/659; F28D 20/00; F28D 20/02; H01M 10/613; H01M 10/625; H01M 10/633

(52) U.S. Cl. CPC H01M 10/659; F28D 20/0056; F28D 20/02; F28D 2021/0028; H01M 10/625; H01M 10/633; H01M 10/613

(57) ABSTRACT

Disclosed is a technique for managing the temperature of rechargeable cells. An energy storage device can include a plurality of rechargeable cells disposed within a housing and a material disposed within the housing so as to completely surround each of the rechargeable cells in a particular plane. The material can have a thermal characteristic such that the material remains a solid upon absorbing heat from the rechargeable cells by changing a crystal lattice structure. Intrinsic latent heat properties of the material result in absorption or release of heat to maintain a temperature of a rechargeable cell within a pre-defined temperature range. A regenerative mechanism including a heat pump coil can restore the material to a lower energy crystal lattice structure.

### CROSS-REFERENCE TO RELATED APPLICATION(S)

This application claims the benefit of U.S. Provisional Patent Application No. 62/638,488, titled “REGENERATIVE SOLID-SOLID PHASE CHANGE COOLING OF BATTERY CELLS FOR ELECTRIC VEHICLES” and filed on Mar. 5, 2018, which is incorporated by reference herein in its entirety.

### TECHNICAL FIELD

At least one embodiment of the technique introduced herein relates to energy storage, and more particularly, to regenerative solid-solid phase change cooling for an energy storage device.

### BACKGROUND

Electric vehicles may soon replace traditional gasoline engine vehicles. The demand for safety, reliability, longer range, lighter weight and lower cost keeps pushing the technology of the electric vehicle in all these areas to advance at a rapid pace.

As the energy density of a battery cell increases, so does the instability of the battery cell and the possible danger to the passengers and surrounding properties. The electric vehicle industry started with the cooling of the battery cells with air. As the volumetric specific heat of water is over three thousand times that of air, the latest cooling system for battery cells is the liquid cooling system. The liquid cooling system is an active cooling system in that the coolant flow is controlled by a thermal control system that meters the temperature of the coolant. A thermal control system can meter temperature via a battery management system and/or thermal controller monitoring temperature changes of the battery cells during charging and discharging while subject to the influence of the environment. The thermal system provides coolant to modulate the temperature of the battery cells. A conventional thermal subsystem includes a heat pump or radiator, radiator fan, condenser, compressor, pump, valves, conduit, and reservoir. Conventional thermal control systems add significant cost and weight to a vehicle.

### BRIEF DESCRIPTION OF THE DRAWINGS

FIG. 1 illustrates a cross-sectional view of a rechargeable cell.

FIG. 2 illustrates a cross-sectional view of a phase change cooling module including more than one energy storage device.

FIG. 3 illustrates a top cross-sectional view of a bus bar with one or more sensors.

FIG. 4 illustrates a top cross-sectional view of a low melting point composite wire interwoven among energy storage devices within a phase change cooling module.

FIG. 5 illustrates a top cross-sectional view of energy storage devices enveloped by a phase change material.

FIG. 6 illustrates an enlarged top cross-sectional view of energy storage devices enveloped by the phase change material.

FIG. 7 illustrates three views of an outer surface of a phase change cooling module.

FIGS. 8A-8B illustrate perspective views of a phase change cooling module including more than one energy storage device.

FIG. 9A is a diagram illustrating a secondary thermal control system having a first heat transfer loop and a second heat transfer loop.

FIG. 9B is a diagram illustrating a secondary thermal control system having a single heat transfer loop configured for a cooling mode and/or a heating mode.

### DETAILED DESCRIPTION

In this description, references to “an embodiment”, “one embodiment” or the like, mean that the particular feature, function, structure or characteristic being described is included in at least one embodiment of the technique introduced here. Occurrences of such phrases in this specification do not necessarily all refer to the same embodiment. On the other hand, the embodiments described are not necessarily mutually exclusive.

The system and technique introduced here involve a phase change material configured to control the temperature of a rechargeable cell (e.g., a battery cell or fuel cell). Heat dissipated by one or more cells during charging and discharging while powering a device (e.g., an electric vehicle) can be absorbed by a solid-solid phase change material. Intrinsic latent heat properties of the solid-solid phase change material result in absorption or release of heat to maintain a temperature of a rechargeable cell within a pre-defined temperature range.

An energy storage device can include a plurality of rechargeable cells enclosed by a top cover, bottom cover, and sidewalls. The solid-solid phase change material can serve as a primary thermal control system. In some embodiments, the energy storage device can include a secondary thermal control system with coolant delivery. The secondary thermal system distributes a liquid coolant to any of the plurality of cells within the enclosure. A conductive layer can extend along the enclosure and carry a current, where a melting point of the conductive layer is lower than a boiling point of the liquid coolant.

The disclosed technique can be employed in electric land vehicles and/or other electric powered vehicles (e.g., an electric airplane, drone, etc.). A rechargeable cell having a phase change material used to control temperature can be much lighter than a rechargeable cell having a coolant delivery system. Thus, an energy storage device having only a primary thermal control system can be advantageous in light weight applications such as, for example, aerial vehicles (e.g., airplanes and drones). When approaching or beyond 300 kw/kg energy density, a phase change energy storage pack can power an airplane with less weight than conventional techniques.

The technique introduced here can be employed to reduce active control thermal systems while having a safe and reliable energy storage cell or module, by using the phase change properties of a solid-solid material or medium used to modulate temperature of an energy storage device. A phase change material (PCM) is a substance, typically with a high heat of fusion, that can store and release large amounts of energy. Most materials, when heated up while in a solid state to a certain temperature, will reach a melting point and change from solid to liquid with an amount of energy called latent heat of fusion. This is the energy required to change the “phase” of the material from solid to liquid and vice versa. However, when a “solid-solid” material reaches the latent stage, it remains a solid, and the latent heat capacity becomes the amount of heat that the material can absorb without increase in temperature. Hence, a “solid-solid” PCM is a material having thermal characteristics such that when it reaches the latent stage while in the solid state, it remains solid rather than turning to liquid. Rather than changing phase (e.g., from solid to liquid), solid-solid materials change their crystalline structure from one lattice configuration to another lattice configuration at a fixed and well-defined temperature. Unlike solid-liquid PCMs, solid-solid PCMs do not require nucleation to prevent supercooling. Additionally, because solid-solid PCMs remain solid upon the crystalline structure change, solid-solid PCMs, unlike other PCMs, do not have problems associated with handling liquids (e.g., containment and potential leakage).

The solid-solid compound used in some embodiments of the disclosed technique can include a paraffin wax compound. The paraffin wax compound can be embedded with a conductive powder including carbon and/or silver. The conductive powder can be made into a solid by mixing it with a resin, which may be a conductive resin. Based on the mixture, a specific conductivity, a latent temperature and corresponding latent energy density can be achieved. For example, a latent temperature may be between approximately 25 and 30 degrees Celsius for application in electric vehicles. A latent temperature between approximately 25 and 30 degrees Celsius may provide operational advantages during charging or discharging. The solid-solid compound remains solid after it has reached and even exceeded its latent temperature. The solid-solid compound absorbs heat generated by the rechargeable cell(s) (e.g., battery cells) and remains at the latent temperature until its latent energy capacity is saturated. After the latent energy capacity of the solid-solid compound is saturated, the temperature of the solid-solid compound will rise without melting. In order to keep the temperature from rising, the latent property of the mixture can be reset or regenerated by removing heat energy from the mixture by heat transfer to the surroundings and/or by using a cooling device.

This solid-solid phase change cooling system is distinct from a liquid cooling system. A liquid cooling system needs a cooling fluid with inlet and outlet connections to a thermal subsystem, such as a radiator, fan, pump, heat exchanger, heating coil, condenser, and compressor. With solid-solid phase cooling, a solid-solid phase change material is used rather than a liquid coolant. The solid-solid phase change material has a specific gravity of approximately 0.9. The solid-solid phase change material is lighter than a typical coolant with a specific gravity of approximately 1.07. The solid-solid phase change material does not require moving parts and conduits, resulting in a simpler, lighter energy storage system. The apparatus or battery module is basically filled with solid-solid phase change material.

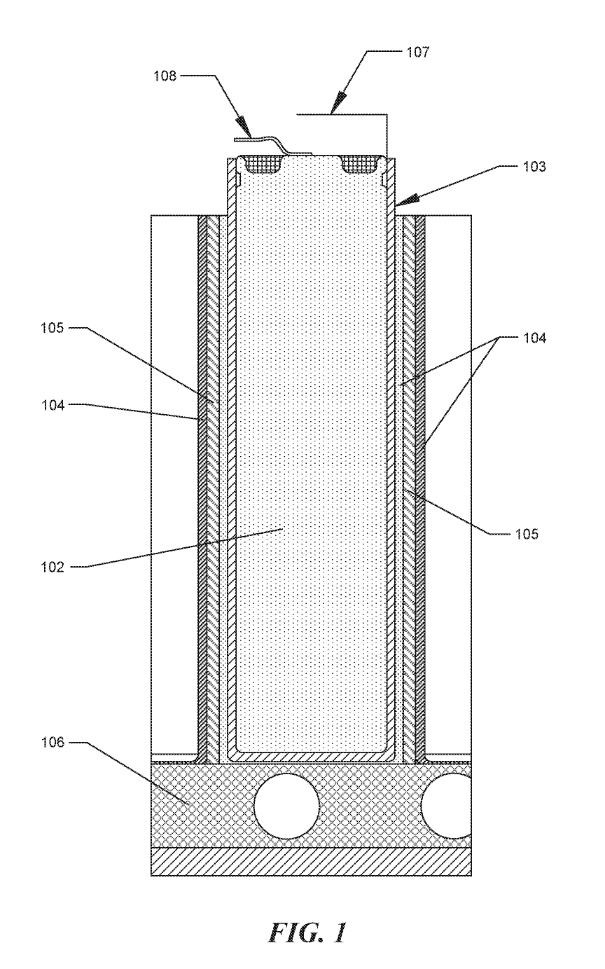

FIG. 1 illustrates a cross-sectional view of a rechargeable cell 102 (e.g., a battery cell or fuel cell) configured for a phase change cooling module (e.g., a solid-solid phase change cooling module). Rechargeable cells can be grouped and connected in parallel and/or in series and contained in the phase change cooling module. Phase change cooling modules can be connected in a structure called an energy storage pack.

In an embodiment, the rechargeable cell 102 can include an electrochemical cell (e.g., a battery cell). Battery cells connected in parallel and/or series and contained in a structure can be referred to as a battery module. Battery modules connected in a structure can be referred to as a battery pack. A battery module or battery pack can cover an area ranging from approximately several square inches to the size of an entire vehicle frame.

The rechargeable cell 102 can be coated by a thin conductive silicone rubber liner 103 that provides an insulative and conductive means for the heat generating rechargeable cell 102. The rechargeable cell 102 and liner 103 are in turn contained inside a thin-walled aluminum cylinder 104. This thin-walled aluminum cylinder 104 separates the rechargeable cells 102 from one another and prevents propagation of explosion from one to another in the event there is a rechargeable cell 102 that may explode (e.g., due to thermal runaway). If a rechargeable cell explodes, the thin-walled aluminum cylinder 104 prevents the explosion from propagating to neighboring cells. The heat, gas, and debris ejected by the explosion will be absorbed by the silicone rubber liner 103. Heat generated by the rechargeable cell 102 will transfer through the thin-walled aluminum cylinder 104 and be absorbed by the solid-solid phase change material 105 surrounding the rechargeable cell 102 (e.g., 360 degrees around the sidewalls of the rechargeable cell 102).

The rechargeable cell 102 can be configured as a cylindrical cell or as a rectangular pouch. The rechargeable cell 102 can be positioned and mounted on a bottom plate 106. The poles of each rechargeable cell 102 are wire-bonded or fused-stripped to a collective pole piece (e.g., a bus bar). The wire(s) (e.g., wires 107 and 108) that bond the pole to the bus bar act as an electrical connection as well as a fuse. If a condition (e.g., a specific current and/or temperature) is exceeded, such as in the event of a thermal runaway, the wire 107 and/or 108 can melt and cause an open circuit, cutting off a defective rechargeable cell.

A bonding wire 108 and the bus bar are both insulated with a layer of insulative silicone rubber. Thus, if the phase change cooling module is crushed or compressed during a collision, the current-carrying conductors will not be in direct contact with one another. In the event uninsulated and current-carrying conductors touch one another, a short circuit and electric spark can occur that may ignite the rechargeable cell 102 leading to a catastrophic explosion event. Accordingly, insulation of conductive elements reduces the likelihood of a catastrophic explosion resulting from short circuiting conducting elements. The insulation of all conductive elements also prevents corrosion by the atmosphere and short circuiting from environmental conditions (e.g., water contact or submersion can cause short circuiting of uninsulated conductors leading to an explosion).

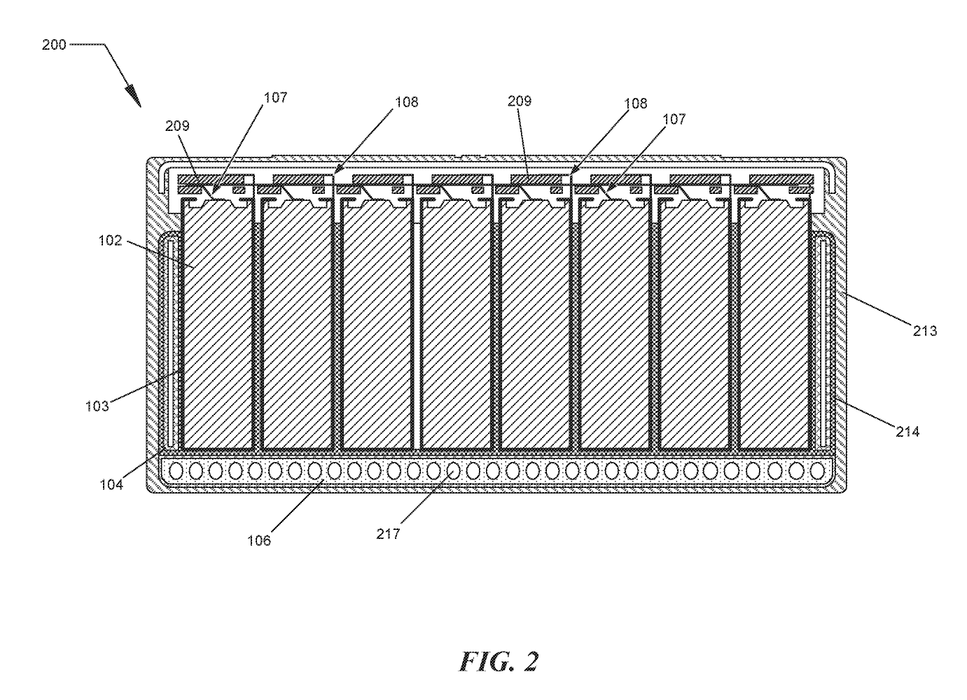

FIG. 2 illustrates a cross-sectional view of a phase change cooling module 200 (e.g., a solid-solid phase change battery module) including rechargeable cells (e.g., rechargeable cell 102). The phase change cooling module 200 can include a plurality of rechargeable cells linked together in series and/or parallel.

The phase change cooling module 200 includes an outer layer 213. The outer layer 213 can be composed of an insulating material such as, for example, silicone rubber. The outer layer 213 can be waterproof, fire retardant, and can withstand a wide operating temperature range. The outer layer 213 insulates the interior from the ambient environment. In an embodiment, the outer layer 213 insulates an interior portion of the phase change cooling module 200 near to an ideal closed system, hardly influenced by its surroundings. The outer layer 213 can absorb shock and vibration.

The phase change cooling module 200 can include thin metal walls on one or more sides. The thin metal walls can be composed of a light metal such as, for example, aluminum. The thin metal walls can be reinforced with backing plates 214 along an outer surface. The metal walls and backing plates 214 can be insulated from an outside environment by the outer layer 213.

The bottom plate 106 is lined with heat transfer conduits that carry the working fluid from a pump. When the phase change material temperature rises above its latent temperature (e.g., approximately 30 degrees Celsius) a heat pump coil 217 is turned on to chill the material to remove heat and reset the material to at or below the latent temperature. In the event the ambient temperature is lower than the operating temperature lower limit of the cells (e.g., approximately 5 degrees Celsius), the heat pump can act as a heater to add heat energy to the phase change cooling module 200.

Rechargeable cells within the phase change cooling module 200 are electrically connect to a bus bar 209. For example, the wires 107 and 108 can electrically connect the rechargeable cells to the bus bar 209. The wires 107 and 108 are configured to terminate an electrical connection between a rechargeable cell and the bus bar 209 upon the rechargeable cell exceeding a temperature threshold. For example, if the rechargeable cell exceeds a melting point of a wire, the wire can melt and cause an open circuit, cutting off the overheating rechargeable cell.

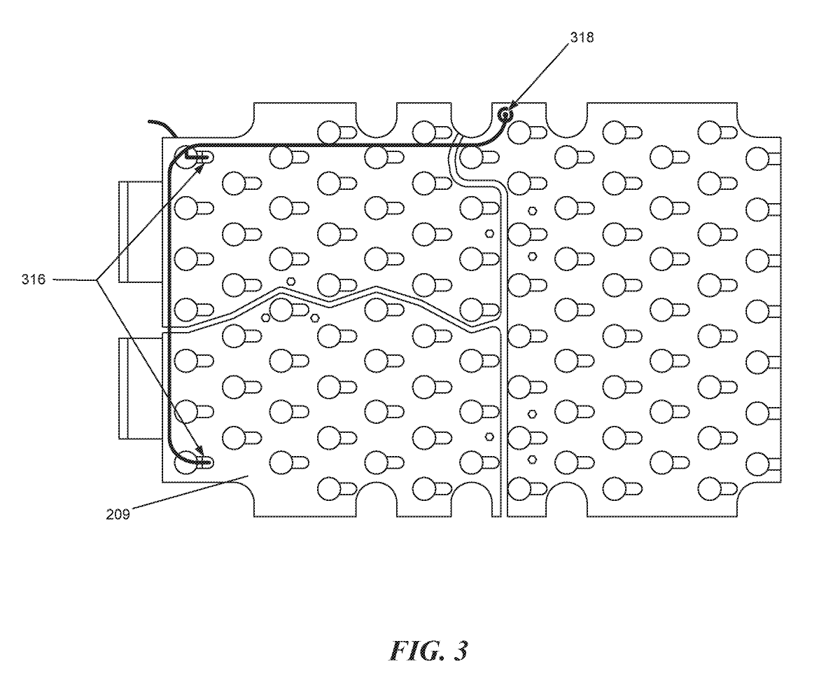

FIG. 3 shows voltage sensor 316 and temperature sensor 318 attached to the bus bar 209. The voltage sensor 316 and temperature sensors 318 can be connected to a Battery Management System (BMS). The BMS can monitor rechargeable cells. For example, the BMS can monitor a charge status, voltage, and temperature of any of the rechargeable cells. The BMS can also balance voltage by operating switches to adjust series and parallel configurations among rechargeable cells.

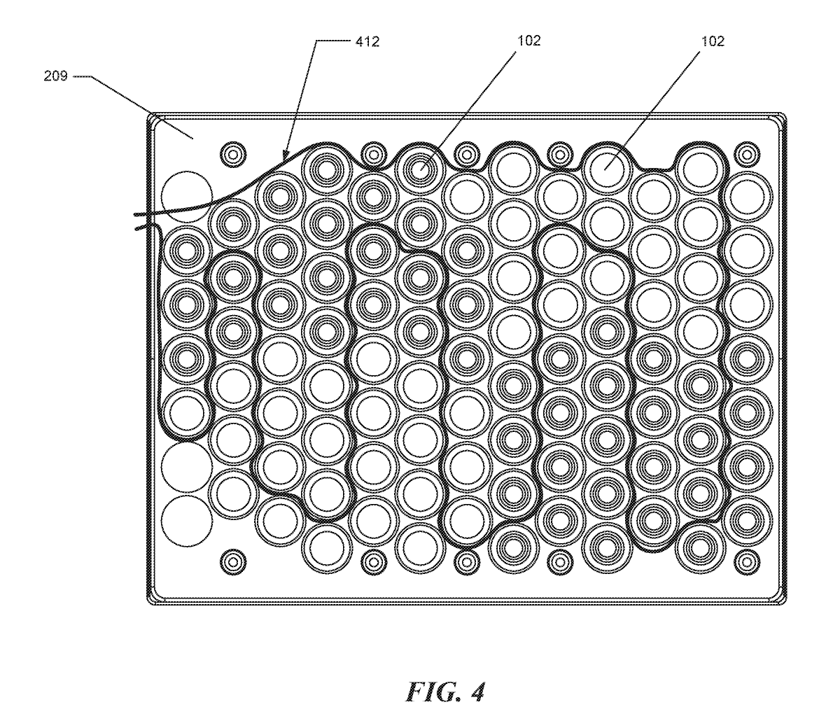

FIG. 4 shows a continuous loop of low melting point composite metal wire 412 on top of bus bar 209. The low melting point composite metal wire 412 is interwoven among energy storage devices 102. The low melting point composite metal wire 412 can be in contact with a portion of the rechargeable cells in a phase change cooling module or in contact with each rechargeable cell within a rechargeable cell module. The low melting point composite metal wire 412 has a melting point of approximately 80 degrees Celsius. For example, the low melting point composite metal wire 412 can have a melting point ranging from approximately 70 degrees Celsius to approximately 90 degrees Celsius. If a rechargeable cell reaches the melting point of the wire 412, the wire 412 melts and causes an open circuit. The open circuit is detected by the BMS. In response to detecting an open circuit, the BMS can terminate operation of the phase change cooling module (e.g., by operating one or more switches).

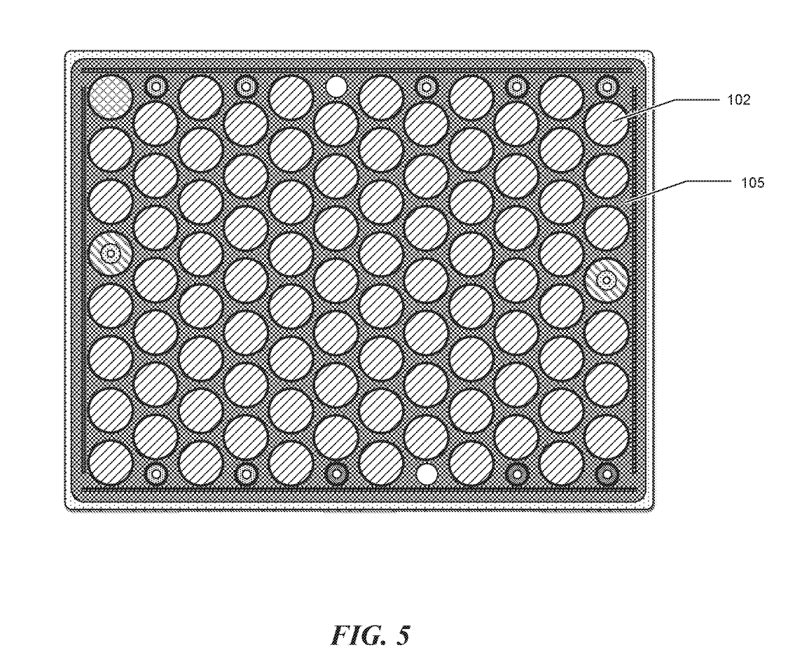

FIG. 5 shows a top view cross-section of a phase change cooling module. The phase change cooling module includes a plurality of rechargeable cells 102 surrounded by a solid-solid phase change material 105. The solid-solid phase change material 105 extends a vertical height and 360 degrees around the energy storage cells 102. The energy storage cells 102 can be embedded into the solid-solid phase change material 105.

Outer structural components of the phase change cooling module can be composed of thin aluminum sheets or a honeycomb panel. The outer structural components of the phase change cooling module can be coated with an outer layer (e.g., out layer 213 of FIG. 2). The outer layer can include, for example, silicone rubber. The outer layer can hermetically seal the edges of the phase change cooling module.

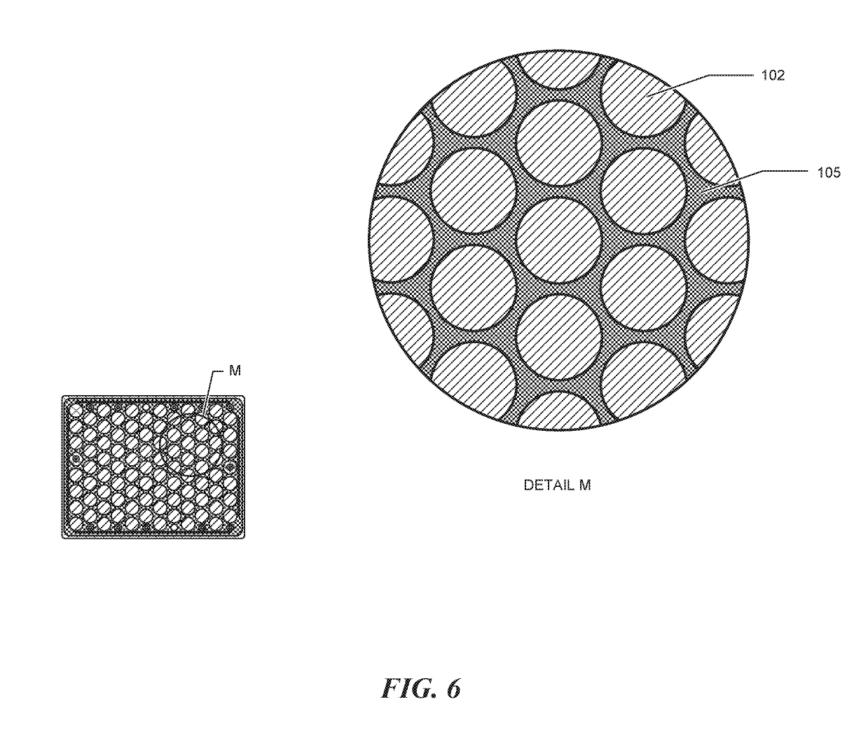

A detailed view M of the energy storage cells 102 is shown in FIG. 6. The solid-solid phase change material 105 can surround a vertical surface of a plurality of energy storage cells distributed throughout a phase change cooling module. The energy storage cells 102 can be distributed in a uniform tiling arrangement including, for example, hexagonal, triangular, square, elongated triangular, trihexagonal, snub square, truncated square, or any combination thereof. For example, the energy storage cells 102 can be distributed in a hexagonal packing arrangement in which the centers of the energy storage cells are arranged in a hexagonal lattice (i.e., staggered rows like a honeycomb). Interior energy storage cells can be adjacent to six other energy storage cells. Exterior energy storage cells can be adjacent to fewer than six other energy storage cells since these cells can also be adjacent to an outer surface (e.g., a thin metal wall and/or a backing plate).

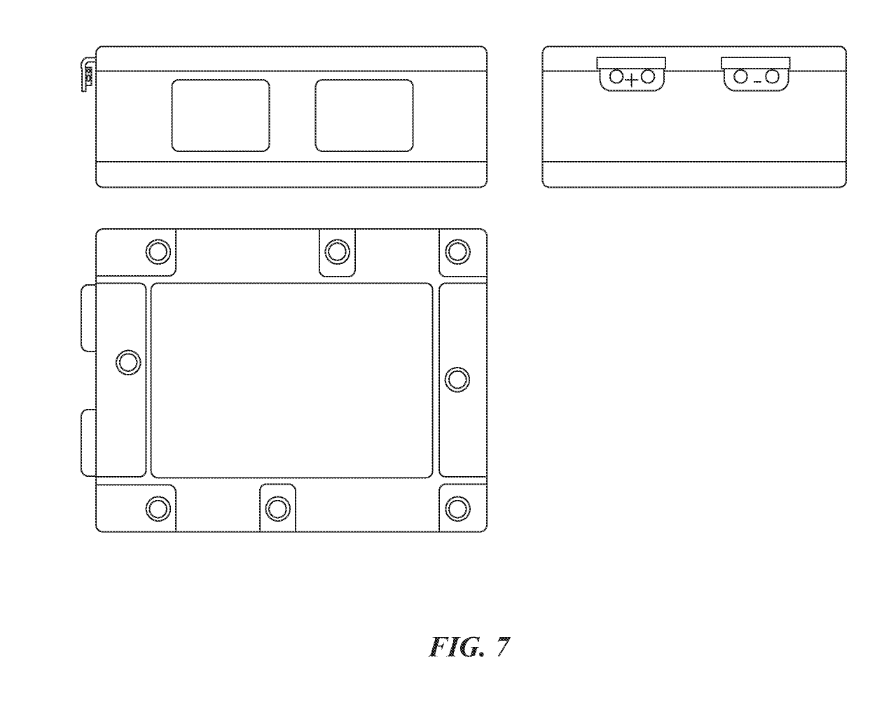

An exterior surface of a phase change cooling module is shown in three views in FIG. 7. The phase change cooling module can include a primary and secondary thermal control system. The primary thermal control system can include a phase change material configured to act as a heat sink. For example, a solid-solid phase change material can absorb heat while increasing in temperature until reaching a latent heat of fusion. Upon reaching the latent heat of fusion, the solid-solid phase change material can continue to absorb heat energy but without increasing in temperature and while remaining a solid. Upon absorbing energy in excess of the heat of fusion, the solid-solid phase change material can remain a solid. The solid-solid phase change material can change from a first crystal lattice structure (e.g., prior to absorbing heat energy equivalent to the latent energy of fusion) and a second crystal lattice structure (e.g., after absorbing heat energy equivalent to the latent energy of fusion).

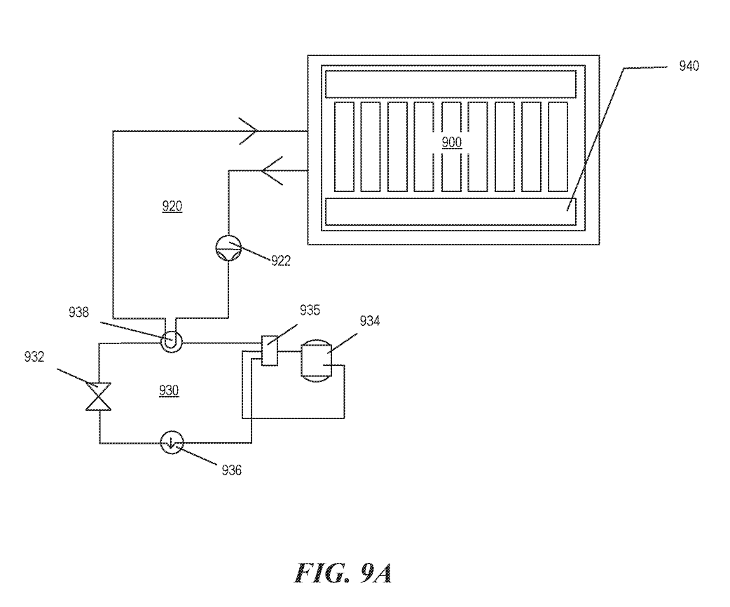

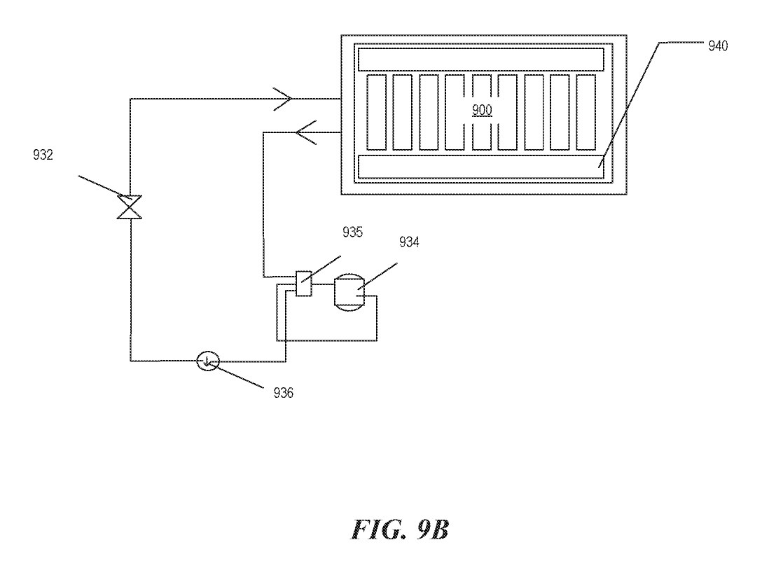

The secondary thermal control system can include a recharge mechanism configured to cause the solid-solid phase change material to return to a lower energy crystal lattice structure (e.g., the crystal lattice structure of the solid-solid phase change material prior to absorbing heat energy equivalent to the latent energy of fusion). Examples of the secondary thermal control system are discussed below with reference to FIGS. 9A-9B.

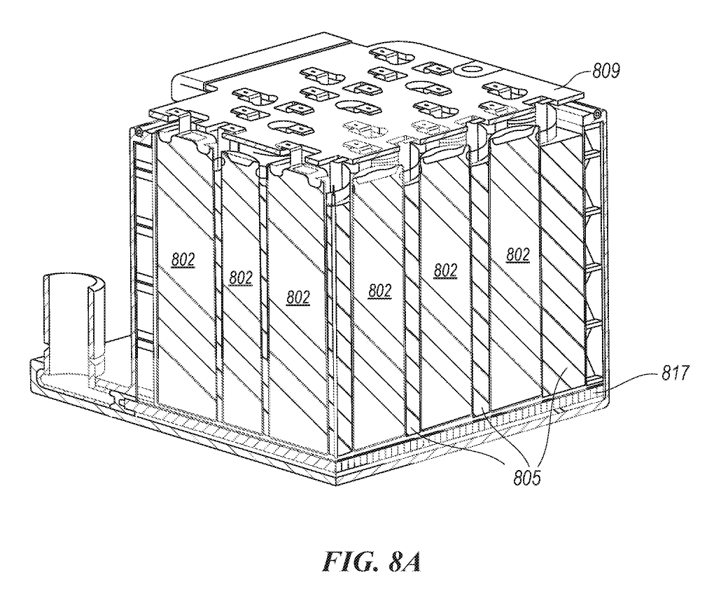

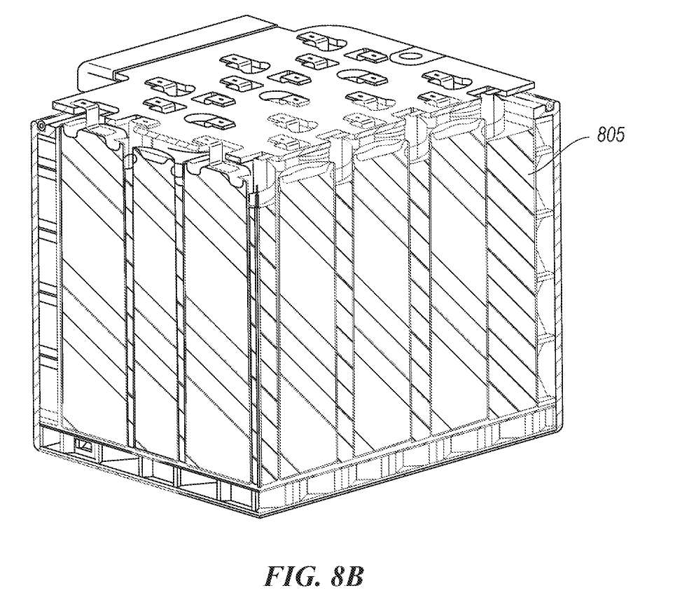

FIGS. 8A and 8B illustrate perspective views of a phase change cooling module including more than one rechargeable cell. FIG. 8A shows the phase change cooling module with rechargeable cells 802 surrounded by a phase change material 805. The rechargeable cells are electrically connected to bus bar 809. The phase change cooling module includes a regenerative mechanism (e.g., including a secondary thermal control system) configured to restore the phase change material 805 to a lower energy crystal lattice structure. The regenerative mechanism includes the cooling and heating conduits 817 (e.g., heat pump coil 217) depicted at the bottom of the structure. The conduits 817 carry the cooling fluid to regenerate the phase change material or to reset the phase change material's latent heat capacity to the original state. The conduits 817 are attached to the heat pump or secondary thermal control systems. Secondary thermal control systems are described below with reference to FIGS. 9A through 9B.

A thermal control system can include be limited to only a primary thermal control system. For example, FIG. 8B does not have cooling or heating conduits at the bottom of the structure. This results in a much lighter structure since there are no heat pumps or a secondary thermal control system. The lighter phase change cooling module is advantageous for electric-powered airplanes and other electric aerial vehicles (e.g., drones).

The thermal control system can include a primary thermal control system (e.g., including a solid-solid material) and a secondary thermal control system configured to regenerate the primary thermal control system. FIGS. 9A through 9B are diagrams illustrating a secondary thermal control of the phase change cooling module. Since the solid-solid phase change material provides primary thermal control, the secondary thermal control system is optional in some embodiments. FIGS. 9A and 9B show a secondary thermal control system utilizing a dual-loop. The thermal control system for the phase change cooling module can be independent of a cooling system for a host vehicle (e.g., the vehicle's heating ventilation and cooling system).

FIG. 9A is a diagram illustrating a first heat transfer loop 920 and a second heat transfer loop 930. The first and second heat transfer loops can regenerate the solid-solid phase change material by causing a crystal lattice structure of the material to change from a high energy crystal lattice structure to a low energy crystal lattice structure. When the phase change cooling module's temperature rises above a latent temperature of a phase change material (e.g., approximately 30 degrees Celsius), the primary loop 920 can be engaged and the secondary loop 930 can operate in cooling mode to remove heat from the phase change cooling module (e.g., via the heat exchange plate 940). For example, a fluid can be directed into a heat pump coil (e.g., heat pump coil 217 of FIG. 2) via a pump 922 to remove heat from a solid-solid phase change material within the phase change cooling module. Heat can be removed until a temperature of the phase change cooling module reaches and/or passes a latent temperature of the solid-solid phase change material.

The secondary loop 930 is configured to operate in a refrigerating mode and a heating mode. The secondary loop 930 includes an expansion valve 932, condenser/evaporator units 936 and 938, compressor 934, and a reversing valve 935. If cooling mode is engaged, condenser/evaporator unit 938 acts as an evaporator and connects the first and second loops 920, 930. If the heating mode is engaged, the reversing valve (e.g., a four-way valve), is reversed compared to cooling mode. In heating mode, the condenser/evaporator unit 938 operates as a condenser and condenser/evaporator unit 936 operates as an evaporator. Thus, in heating mode, the secondary loop 930 acts as a heat pump. If ambient temperature is lower than the operating temperature lower limit of the cells (e.g., approximately 5 degrees Celsius), the primary loop 920 can be engaged and the secondary loop 930 can operate in heating mode to add heat energy to the phase change cooling module.

The phase change material acts as both a heat sink and heat reservoir, reducing the need to utilize the secondary thermal control system. If the phase change cooling module's temperature rises above a latent temperature of a phase change material (e.g., approximately 30 degrees Celsius) or below an operating temperature lower limit of the rechargeable cells (e.g., approximately 5 degrees Celsius), the secondary thermal control system (e.g., in heating or cooling mode) can be engaged. A control circuit can cause the secondary thermal control system to engage by, for example, activating a pump (e.g., pump 922 of primary loop 920) and causing the secondary loop to operate in either heating or cooling mode (e.g., by regulating the reversing valve 935). The control circuit can determine whether to cause the secondary loop to operate in a heating or cooling mode based on which threshold is crossed. For example, if the latent temperature of the phase change material is exceeded, the control circuit can cause the secondary loop to operate in the cooling mode. If a lower limit of an operating temperature for rechargeable cells is exceeded, the control circuit can cause the secondary loop to operate in the heating mode.

FIG. 9B shows a single-loop secondary thermal control system. The single-loop secondary thermal control system can be used for both an energy storage device and as a heating ventilation and cooling system for a host vehicle. The single-loop secondary thermal control system is configured to operate in a heating mode and/or cooling mode. The single-loop secondary thermal control system can regenerate the solid-solid phase change material by causing a crystal lattice structure of the material to change from a high energy crystal lattice structure to a low energy crystal lattice structure. Although the single-loop secondary thermal control system is only shown as being connected to an energy storage module 900, the secondary thermal control system can also be shared with a host vehicle. The single-loop secondary thermal control system can include an expansion valve 932, compressor 934, condenser/evaporator unit 936, reversing valve 935, and heat exchange plate 940. During cooling mode, the energy storage module 900 operates as an evaporator and the heat exchange plate 940 operates as a condenser. During heating mode, a four-way valve (e.g., reversing valve 935) reverses flow causing the energy storage module 900 to operate as a condenser and the heat exchange plate 940 to operate as an evaporator.

A regeneration mechanism (e.g., the secondary thermal control system) can be initiated upon passing a temperature threshold (e.g., a temperature indicative of a thermal capacity of a solid-solid phase change material). A control circuit can determine whether any of the temperature thresholds have been reached and/or passed. In response to determining that the temperature threshold has been reached and/or passed, the control circuit can engage components of the secondary thermal control system to initiate the heating mode or cooling mode depending on the particular temperature threshold that is reached and/or passed. If the phase change material temperature passes (e.g., rises above) a latent temperature of a phase change material (e.g., approximately 30 degrees Celsius), the cooling mode can be initiated. If the phase change material temperature drops below the latent temperature of the phase change material (e.g., approximately 28 degrees Celsius), the cooling mode can be terminated. If the phase change material temperature drops below an operating temperature lower limit of the cells (e.g., approximately 5 degrees Celsius), the heating mode can be initiated. The heating mode can be initiated by causing a flow to reverse via the reversing valve 935 and engaging the compressor 934. If the phase change material temperature rises above the operating temperature lower limit of the cells (e.g., approximately 7 degrees Celsius), the heating mode can be terminated.

From the foregoing, it will be appreciated that specific embodiments of the invention have been described herein for purposes of illustration, but that various modifications may be made without deviating from the scope of the invention. Accordingly, the invention is not limited except as by the appended claims.

What is claimed is:

1. An energy storage module comprising:
a plurality of rechargeable cells disposed within a housing; and
a material disposed within the housing so as to completely surround each of the rechargeable cells in a particular plane, the material having a thermal characteristic such that the material remains a solid upon absorbing heat from the rechargeable cells by changing a crystal lattice structure of the material.

2. The energy storage module of claim 1, wherein the material occupies substantially all space between the plurality of rechargeable cells within the energy storage module.

3. The energy storage module of claim 1, wherein a latent solid-solid phase change temperature of the material is between approximately 25 and 30 degrees Celsius.

4. The energy storage module of claim 1, wherein upon reaching a latent solid-solid phase change temperature, the material experiences a crystal lattice change while maintaining an approximately constant temperature.

5. The energy storage module of claim 1, wherein the material has characteristics such that it can have at least a first crystal lattice structure and a second crystal lattice structure at different times, and such that the material remains solid despite changing between the first and second crystal lattice structures.

6. The energy storage module of claim 1, further comprising:
a regenerative mechanism configured to restore the material from the crystal lattice structure to a lower energy crystal lattice structure.

7. The energy storage module of claim 6, wherein the regenerative mechanism includes a heat transfer loop that initiates upon detection of a temperature threshold.

8. The energy storage module of claim 1, further comprising:
a control unit configured to detect whether an upper temperature threshold and/or lower temperature threshold of the rechargeable cells is passed.

9. The energy storage module of claim 8, wherein the upper temperature threshold is a latent solid-solid phase change temperature of the material.

10. The energy storage module of claim 8, wherein the lower temperature threshold is an operating temperature limit of the rechargeable cells.

11. The energy storage module of claim 8, wherein the control unit is configured to initiate a heating mode of a secondary thermal control system upon detecting the lower temperature threshold being passed and a cooling mode of the secondary thermal control system upon detecting the upper temperature threshold being passed.

12. The energy storage module of claim 1, further comprising:
a bottom plate having heat transfer conduits configured to carry a fluid to exchange heat with the material, the heat transfer conduits being configured to connect to a secondary thermal control system.

13. A thermal management system comprising:
a material adjacent and external to a sidewall of a rechargeable cell, the material having a thermal characteristic such that the material remains a solid upon absorbing heat from the rechargeable cell by changing from a first crystal lattice structure to a second crystal lattice structure; and
a regenerative mechanism configured to restore the material from the second crystal lattice structure to the first crystal lattice structure.

14. The thermal management system of claim 13, wherein the regenerative mechanism includes a heat transfer loop that initiates upon detection of any of a lower temperature threshold being passed and an upper temperature threshold being passed.

15. The thermal management system of claim 14, wherein the upper temperature threshold is a latent solid-solid phase change temperature of the material, and the lower temperature threshold is an operating temperature limit of the rechargeable cells.

16. The thermal management system of claim 14, wherein a control unit initiates a heating mode of the regenerative mechanism upon detecting the lower temperature threshold being passed and a cooling mode of the regenerative mechanism upon detecting the upper temperature threshold being passed.

17. The thermal management system of claim 13, wherein the rechargeable cell is among a plurality of rechargeable cells disposed in a housing, and wherein the material occupies a majority of space between the rechargeable cells within the housing.

18. The thermal management system of claim 13, further comprising:
a control unit configured to detect an upper temperature threshold by monitoring a continuous loop of low melting point composite metal wire interwoven among rechargeable cells, the low melting point composite metal wire being configured to melt upon exceeding the upper temperature threshold.

19. An energy storage module comprising:
a rechargeable cell disposed within a housing; and
a material disposed within the housing and adjacent to a sidewall of the rechargeable cell, the material having a thermal characteristic such that upon passing a latent solid-solid phase change temperature, the material maintains a constant temperature and remains a solid.

20. The energy storage module of claim 19, wherein the material maintains the constant temperature by changing from a first crystal lattice structure to a second crystal lattice structure.

21. The energy storage module of claim 19, further comprising:
a secondary thermal control system configured to restore the material from a high energy crystal lattice structure to a lower energy crystal lattice structure, the secondary thermal control system including:
a control unit configured to detect a latent solid-solid phase change temperature of the material and an operating temperature limit of the rechargeable cells; and
a heat transfer loop configured to initiate upon detection of either temperature threshold.

22. The energy storage module of claim 21, wherein the heat transfer loop includes a reversible valve configured to cause the heat transfer loop to change between a heating mode and a cooling mode,
wherein the cooling mode is engaged upon detection of the latent solid-solid phase change temperature of the material, and
wherein the heating mode is engaged upon detection of the operating temperature limit of the rechargeable cells.
